(19) United States
(12) Patent Application Publication
(10) Pub. No.: US 2026/0344754 A1
(43) Pub. Date: Nov. 5, 2026

(54) AEROSOL-GENERATING DEVICE AND AEROSOL-DELIVERY SYSTEM

(71) Applicant: Philip Morris Products S.A., Neuchatel (CH)

(72) Inventors: Guoqiang CAI, Shenzhen (CN); Dingbo CHENG, Guangdong (CN); Hongjie XU, Hong Kong (HK)

(73) Assignee: Philip Morris Products S.A., Neuchatel (CH)

(21) Appl. No.: 19/108,024

(22) PCT Filed: Sep. 5, 2022
(86) PCT No.: PCT/CN2022/117058

§ 371 Date: Feb. 28, 2025

(51) Int. Cl. A24F 40/40; A24F 40/20; H01M 4/02; H01M 4/1315; H01M 4/133; H01M 10/0525; H01M 10/0567; H01M 10/0569; H01M 50/247

(52) U.S. Cl. CPC A24F 40/40; A24F 40/20; H01M 4/1315; H01M 4/133; H01M 10/0525; H01M 10/0567; H01M 10/0569; H01M 2004/027; H01M 2004/028; H01M 50/247; H01M 2300/0034

(57) ABSTRACT

An aerosol-generating device for generating an inhalable aerosol from an aerosol-forming substrate is provided, the aerosol-generating device including: a lithium-ion battery including an electrolyte and at least one pair of electrodes, the at least one pair of electrodes being spaced apart from each other in the electrolyte, one of the pair of electrodes defining an anode and including an anode-active material, the other of the pair of electrodes defining a cathode and including a cathode-active material, and the electrolyte including a halogenated carbonate, the halogenated carbonate including one or more of difluoroethylene carbonate, trifluoropropylene carbonate, 4-[(2,2,3,3-tetrafluoropropoxy)methyl]-1,3-dioxolan-2-one, 4-(2,2,3,3,4,4,5,5,5-nonafluoropenty1)-1,3-dioxolan-2-one, bis(2,2,2-trifluoroethyl) carbonate, and 2,2,3,4,4,4-hexafluorobutyl methyl carbonate.

The present disclosure relates to an aerosol-generating device and an aerosol delivery system.

Aerosol-generating devices configured to generate an aerosol from an aerosol-forming substrate, such as a tobacco-containing substrate, are known in the art. To provide portability, it is known for such aerosol-generating devices to incorporate their own on-board power source, such as a battery. It is known for such aerosol-generating devices to use heat as a mechanism for evolving volatile compounds from an aerosol-forming substrate, with the battery providing the electrical energy needed to drive the heating process. The temperatures required to evolve volatile compounds from an aerosol-forming substrate can be in excess of 300 degrees Celsius. Where the aerosol-forming substrate is in liquid form, it is also known for an aerosol to be generated by bringing the substrate into contact with a vibrating membrane, with the battery providing the energy necessary to generate a driving signal to induce the vibration. The usage session for a consumable aerosol-generating article containing aerosol-forming substrate is of finite length, typically being of the order of minutes. Whether heat or vibration is used as the mechanism for generating an aerosol from an aerosol-forming substrate, the battery used to provide the electrical energy necessary to drive the aerosol generation process is required to deliver a large amount of energy in a short amount of time. It is also desirable that the battery has a capacity sufficient to satisfy the energy requirements of the aerosol-generating device over at least one usage session. Portable aerosol-generating devices may also be used in all kinds of different environments and temperatures. It is known that low temperature environments can adversely affect the performance of known batteries.

It is therefore desired to provide an aerosol-generating device having an improved battery.

According to a first aspect of the present disclosure, there is provided an aerosol-generating device for use in generating an inhalable aerosol from an aerosol-forming substrate. The aerosol-generating device comprises a lithium-ion battery. The battery comprises an electrolyte and at least one pair of electrodes. The pair of electrodes are spaced apart from each other in the electrolyte. One of the pair of electrodes defines an anode and comprises an anode-active material. The other of the pair of electrodes defines a cathode and comprises a cathode-active material. The electrolyte includes a halogenated carbonate.

Lithium-ion batteries are particularly suitable for aerosol-generating devices due to characteristics of high energy density and low self-discharge. The use of a halogenated carbonate may facilitate the battery having increased performance at low temperatures. Preferably, the battery may be a rechargeable battery. Where the battery is rechargeable, the use of a halogenated carbonate may facilitate the battery having an improved cycle life. By “improved cycle life” is meant that after a predetermined number of charge cycles, the battery retains a higher maximum capacity (as a percentage of the initial capacity of the battery in its “as-new” state) than batteries lacking halogenated carbonate. By “charge cycle” is meant a period of use of the battery from being fully charged to fully discharged, and then being fully re-charged; the term “charge/discharge cycle” may be used in place of the term “charge cycle”. The term “capacity” when referring to the capacity of a battery is a measure of the charge stored by the battery; the capacity is commonly expressed in Ampere-hours (A-h).

The pair of electrodes and the electrolyte may form components of a discrete cell of the battery. The battery may comprise a single cell or a plurality of cells.

The halogenated carbonate may comprise one or more of fluoroethylene carbonate (FEC), difluoroethylene carbonate (DFEC), trifluoropropylene carbonate (TFPC), 4-[(2,2,3,3-tetrafluoropropoxy)methyl]-1,3-dioxolan-2-one (HFEEC), 4-(2,2,3,3,4,4,5,5,5-nonafluoropentyl)-1,3-dioxolan-2-one (NFPEC), bis(2,2,2-trifluoroethyl) carbonate (TFEC) and 2,2,3,4,4,4-hexafluorobutyl methyl carbonate (HFBMC). Advantageously, the halogenated carbonate may comprise or consist of fluoroethylene carbonate (FEC). As will be discussed in more detail in the specific description, it has been found that the use of FEC as a constituent of the electrolyte provides an improved life cycle for the battery relative to a battery identical in all respects other than lacking FEC in the electrolyte.

The halogenated carbonate may be present in the electrolyte in a concentration of 0.05% to 15% by weight of the electrolyte, or between 0.05% to 10% by weight of the electrolyte, or between 0.05% to 5% by weight of the electrolyte, or between 0.1% to 2% by weight of the electrolyte.

Advantageously, the electrolyte may comprise a lithium salt. The lithium salt may function as a source of lithium ions for the battery. The lithium salt may comprise one or more of more of LiPF₆, LiBF₄, LiSbF₆, LiAsF₆, LiClO₄, LiCF₃SO₃, LiN(SO₂CF₃)₂, LiN(SO₂C₂F₅)₂, LiC(SO₂CF₃)₃, LiN(SO₃CF₃)₂, LiC₄F₉SO₃, LiAlO₄, LiAlCl₄, LiCl, and Lil. Preferably, the lithium salt may comprise or consist of LiPF₆. The electrolyte may include a solvent in addition to a lithium salt. The solvent functions as a medium for the passage of ions associated with the electrochemical reactions which occur within the battery during use. The solvent may be an aqueous solvent or a non-aqueous solvent. LiPF₆ has characteristics of solubility and high ionic conductivity within a solvent. The solvent may comprise a non-aqueous organic solvent comprising one or more of propylene carbonate (PC), ethylene carbonate (EC), and ethyl methyl carbonate (EMC).

The anode-active material may comprise one or more of carbon, an allotrope of carbon, lithium titanate oxide, and silicon. Preferably, the allotrope of carbon comprises or consists of graphite. The graphite may be natural graphite or synthetically produced. Graphite is preferred as an anode-active material because of its high electrical conductivity and ability to reversibly place lithium ions between its constituent layers, with this ability being maintained over thousands of charge cycles.

The anode may further comprise an anode collector. A coating comprising the anode-active material may be applied to the anode collector. The coating may be applied to the anode collector by a baking operation. The anode collector may comprise copper. Alternatively, the anode collector may comprise nickel. The anode collector may be in the form of a foil. The anode collector may have a meshed construction.

The cathode-active material may comprise one or more of lithium iron phosphate, lithium nickel-cobalt-aluminium oxide, lithium-cobalt oxide, lithium-manganese oxide, lithium-nickel-manganese oxide, lithium-manganese-cobalt oxide, lithium-nickel-manganese-cobalt oxide, and lithium sulphur. Preferably, the cathode-active material comprises or consists of lithium iron phosphate. Lithium iron phosphate has characteristics of thermal stability and a long cycle life.

The cathode may further comprise a cathode collector. A coating comprising the cathode-active material may be applied to the cathode collector. The coating may be applied to the cathode collector by a baking operation. The cathode collector may comprise aluminium. In a similar manner to the anode collector, the cathode collector may be in the form of a foil and/or have a meshed construction.

The coating applied to the anode collector and the coating applied to the cathode collector may each further comprise a binder, a conductive agent and a stabiliser. The binder, conductive agent and stabiliser may be mixed in with a solvent-either aqueous or non-aqueous. The solvent may comprise one or more of N-methyl-2-pyrrolidone (NMP), dimethylformamide (DMF), dimethylacetamide, N,N-dimethylaminopropylamine, ethylene oxide, and tetrahydrofuran (THF).

The binder may facilitate mixing the constituent ingredients of the coating into a paste or a slurry. The binder may also facilitate adhering the coating material to the anode or cathode collector. The binder may comprise one or more of polyvinylidenefluoride (PVDF), polyhexafluoropropylene-polyvinylidenefluoride copolymer, poly(vinylacetate), polyvinylalcohol, polyethyleneoxide (PEO), polyvinylpyrrolidone (PVP), alkylated polyethyleneoxide, polyvinylether (PVE), poly(methylmethacrylate) (PMMA), poly(ethylacrylate), polytetrafluorethylene (PTFE), polyvinylchloride (PVC), polyacrylonitrile (PAN), polyvinylpyridine, styrene-butadiene rubber (SBR), and acrylonitrile-butadiene rubber. The binder may be present in the respective coating in a concentration of 0.1% to 30% by weight of the coating, or preferably 1% to 10% by weight of the coating.

The conductive agent may comprise one or more of a graphitic agent, a carbon-black agent, a metal, and a metallic compound agent. Where the conductive agent comprises a graphitic agent, the graphitic agent may comprise one or more of artificial graphite and natural graphite. Where the conductive agent comprises a carbon-black agent, the carbon-black agent may comprise one or more of acetylene black, ketjen black, denka black, thermal black, and channel black. Where the conductive agent comprises a metal or metallic compound agent, the metal or metallic compound agent may comprise one or more of Sn, SnO₂, SnPO₄, TiO₂, KTiO₃, LaSrCoO₃, and LaSrMnO₃. The conductive agent may be present in the coating in a concentration of 0.1% to 10% by weight of the coating. Limiting the concentration of the conductive agent to be no more than 10% by weight of the coating may be beneficial in terms of the energy density per unit weight. Maintaining the concentration of the conductive agent to be no less than 0.1% by weight of the coating may be beneficial in enhancing electrochemical characteristics of the coating.

The stabiliser may comprise one or more of carboxylmethyl cellulose, hydroxymethyl cellulose, hydroxyethyl cellulose, and hydroxypropyl cellulose. The stabiliser may be selected to adjust the viscosity of a slurry of the anode-/cathode-active material for use in forming the coating.

Preferably the battery may further comprise a permeable barrier configured to allow passage of lithium ions there-through, the permeable barrier positioned in the electrolyte between the anode and cathode. The permeable barrier facilitates preventing a short circuit between the anode and cathode, whilst also permitting the passage of ionic charge carriers between the anode and cathode during use of the battery. Conveniently, the permeable barrier is formed of a polymer material. The permeable barrier may comprise one or a plurality of layers. The permeable barrier may have a porous construction. The permeable barrier may be formed of any one or more of a multilayer film, a microporous film, a woven fabric, and a non-woven fabric. The material selected for the permeable barrier will preferably be one which is chemically non-reactive with the electrolyte and/or with ions evolved from the anode and cathode during use of the battery.

In an advantageous embodiment, the halogenated carbonate may comprise fluoroethylene carbonate (FEC). Preferably, the cathode-active material may comprise lithium iron phosphate. Preferably, the electrolyte may comprise LiPF6.

Conveniently, the cathode-active material may comprise one or more of lithium iron phosphate, lithium-nickel-manganese-cobalt oxide and lithium-cobalt oxide. The anode-active material may comprise graphite.

The battery may provide electrical power to support functioning of the aerosol-generating device in generating an inhalable aerosol from an aerosol-forming substrate.

Where heating of an aerosol-forming substrate is used in generating an aerosol from the substrate, the aerosol-generating device may further comprise an electrically-powered heating arrangement and control electronics configured to control a supply of energy from the battery to the heating arrangement. The heating arrangement may take various forms. In one example, the electrically-powered heating arrangement may comprise a resistive heating element. In another example, the electrically-powered heating arrangement may comprise an inductor configured to induce eddy currents into a susceptor. The susceptor may form part of the heating arrangement. Alternatively, the susceptor may form part of an aerosol-generating article to be used with the aerosol-generating device, the article containing an aerosol-forming substrate. The susceptor may be embedded within the aerosol-forming substrate.

Where vibration of a membrane is used in generating an aerosol from the substrate, the aerosol-generating device may further comprise a membrane for evolving an aerosol from an aerosol-forming substrate through vibration of the membrane. An actuator may be coupled to the membrane. The aerosol-generating device may further comprise control electronics configured to control a supply of energy from the battery to the actuator to drive vibration of the membrane.

Preferably, the aerosol-generating device may be configured to receive an aerosol-generating article comprising an aerosol-forming substrate.

Preferably, the aerosol-generating device is configured in size and mass to be hand-held. Conveniently, the aerosol-generating device is generally elongate; by way of example the aerosol-generating device may be generally cylindrical.

According to another aspect of the present disclosure, there is provided an aerosol-delivery system comprising an aerosol-generating device according to any of the variants discussed above. The aerosol-delivery system may further comprise an aerosol-generating article comprising an aerosol-forming substrate. The aerosol-generating device may be configured to receive the aerosol-generating article.

As used herein, the term “aerosol-generating device” is used to describe a device that interacts with an aerosol-forming substrate of an aerosol-generating article to generate an aerosol. Preferably, the aerosol-generating device is a smoking device that interacts with an aerosol-forming substrate of an aerosol-generating article to generate an aerosol that is directly inhalable into a user's lungs thorough the user's mouth. The aerosol-generating device may be a holder for a smoking article.

Preferably, the aerosol-generating article is a smoking article that generates an aerosol that is directly inhalable into a user's lungs through the user's mouth. More, preferably, the aerosol-generating article is a smoking article that generates a nicotine-containing aerosol that is directly inhalable into a user's lungs through the user's mouth.

As used herein, the term “aerosol-forming substrate” denotes a substrate consisting of or comprising an aerosol-forming material that is capable of releasing volatile compounds upon heating to generate an aerosol.

As used herein, the term “aerosol-forming material” denotes a material that is capable of releasing volatile compounds upon heating to generate an aerosol. An aerosol-forming substrate may comprise or consist of an aerosol-forming material.

As used herein, the terms “upstream” and “downstream” are used to describe the relative positions of elements, or portions of elements, of the heated aerosol-generating article in relation to the direction in which a user draws on the aerosol-generating article during use thereof.

Preferably, the aerosol-forming substrate is a solid aerosol-forming substrate. However, the aerosol-forming substrate may comprise both solid and liquid components. Alternatively, the aerosol-forming substrate may be a liquid aerosol-forming substrate.

Preferably, the aerosol-forming substrate comprises nicotine. More preferably, the aerosol-forming substrate comprises tobacco. Alternatively or in addition, the aerosol-forming substrate may comprise a non-tobacco containing aerosol-forming material.

If the aerosol-forming substrate is a solid aerosol-forming substrate, the solid aerosol-forming substrate may comprise, for example, one or more of: powder, granules, pellets, shreds, strands, strips or sheets containing one or more of: herb leaf, tobacco leaf, tobacco ribs, expanded tobacco and homogenised tobacco.

Optionally, the solid aerosol-forming substrate may contain tobacco or non-tobacco volatile flavour compounds, which are released upon heating of the solid aerosol-forming substrate. The solid aerosol-forming substrate may also contain one or more capsules that, for example, include additional tobacco volatile flavour compounds or non-tobacco volatile flavour compounds and such capsules may melt during heating of the solid aerosol-forming substrate.

Optionally, the solid aerosol-forming substrate may be provided on or embedded in a thermally stable carrier. The carrier may take the form of powder, granules, pellets, shreds, strands, strips or sheets. The solid aerosol-forming substrate may be deposited on the surface of the carrier in the form of, for example, a sheet, foam, gel or slurry. The solid aerosol-forming substrate may be deposited on the entire surface of the carrier, or alternatively, may be deposited in a pattern in order to provide a non-uniform flavour delivery during use.

In a preferred embodiment, the aerosol-forming substrate comprises homogenised tobacco material. As used herein, the term “homogenised tobacco material” refers to a material formed by agglomerating particulate tobacco.

Preferably, the aerosol-forming substrate comprises a gathered sheet of homogenised tobacco material. As used herein, the term “sheet” refers to a laminar element having a width and length substantially greater than the thickness thereof. As used herein, the term “gathered” is used to describe a sheet that is convoluted, folded, or otherwise compressed or constricted substantially transversely to the longitudinal axis of the aerosol-generating article.

Preferably, the aerosol-forming substrate comprises an aerosol former. As used herein, the term “aerosol former” is used to describe any suitable known compound or mixture of compounds that, in use, facilitates formation of an aerosol and that is substantially resistant to thermal degradation at the operating temperature of the aerosol-generating article.

Suitable aerosol-formers are known in the art and include, but are not limited to: polyhydric alcohols, such as propylene glycol, triethylene glycol, 1,3-butanediol and glycerine; esters of polyhydric alcohols, such as glycerol mono-, di-or triacetate; and aliphatic esters of mono-, di- or polycarboxylic acids, such as dimethyl dodecanedioate and dimethyl tetradecanedioate. Preferred aerosol formers are polyhydric alcohols or mixtures thereof, such as propylene glycol, triethylene glycol, 1,3-butanediol and, most preferred, glycerine.

The aerosol-forming substrate may comprise a single aerosol former. Alternatively, the aerosol-forming substrate may comprise a combination of two or more aerosol formers.

The invention is defined in the claims. However, below there is provided a non-exhaustive list of non-limiting examples. Any one or more of the features of these examples may be combined with any one or more features of another example, embodiment, or aspect described herein.

Example Ex1: An aerosol-generating device for use in generating an inhalable aerosol from an aerosol-forming substrate, the aerosol-generating device comprising:
a lithium-ion battery;
wherein the battery comprises an electrolyte and at least one pair of electrodes, the pair of electrodes spaced apart from each other in the electrolyte, one of the pair of electrodes defining an anode and comprising an anode-active material, the other of the pair of electrodes defining a cathode and comprising a cathode-active material;
the electrolyte including a halogenated carbonate.

Example Ex2: An aerosol-generating device according to Ex1, in which the halogenated carbonate comprises one or more of fluoroethylene carbonate, difluoroethylene carbonate, trifluoropropylene carbonate, 4-[(2,2,3,3-tetrafluoropropoxy)methyl]-1,3-dioxolan-2-one, 4-(2,2,3,3,4,4,5,5,5-nonafluoropentyl)-1,3-dioxolan-2-one, bis(2,2,2-trifluoroethyl) carbonate and 2,2,3,4,4,4-hexafluorobutyl methyl carbonate.

Example Ex3: An aerosol-generating device according to either one of Ex1 or Ex2, in which the halogenated carbonate is present in the electrolyte in a concentration of 0.05% to 15% by weight of the electrolyte, or between 0.05% to 10% by weight of the electrolyte, or between 0.05% to 5% by weight of the electrolyte, or between 0.1% to 2% by weight of the electrolyte.

Example Ex4: An aerosol-generating device according to any one of Ex1 to Ex3, in which the electrolyte comprises a lithium salt.

Example Ex5: An aerosol-generating device according to Ex4, in which the lithium salt comprises one or more of more LiPF₆, LiBF₄, LiSbF₆, LiAsF₆, LiClO₄, LiCF₃SO₃, LiN(SO₂CF₃)₂, LiN(SO₂C₂F₅)₂, LiC(SO₂CF₃)₃, LiN(SO₃CF₃)₂, LiC₄F₉SO₃, LiAlO₄, LiAlCl₄, LiCl, and Lil.

Example Ex6: An aerosol-generating device according to any one of Ex1 to Ex5, in which the anode-active material comprises one or more of carbon, an allotrope of carbon, lithium titanate oxide, and silicon.

Example Ex7: An aerosol-generating device according to Ex6, in which the allotrope of carbon comprises graphite.

Example Ex8: An aerosol-generating device according to any one of Ex1 to Ex7, in which the anode further comprises an anode collector, wherein a coating comprising the anode-active material is applied to the anode collector.

Example Ex9: An aerosol-generating device according to Ex8, in which the anode collector comprises copper.

Example Ex 10: An aerosol-generating device according to any one of Ex1 to Ex9, in which the cathode-active material comprises one or more of lithium iron phosphate, lithium nickel-cobalt-aluminium oxide, lithium-cobalt oxide, lithium-manganese oxide, lithium-nickel-manganese oxide, lithium-manganese-cobalt oxide, lithium-nickel-manganese-cobalt oxide, and lithium sulphur.

Example Ex11: An aerosol-generating device according to any one of Ex1 to Ex10, in which the cathode further comprises a cathode collector, wherein a coating comprising the cathode-active material is applied to the cathode collector.

Example Ex12: An aerosol-generating device according to Ex11, in which the cathode collector comprises aluminium.

Example Ex13: An aerosol-generating device according to either one of Ex8 or Ex11, in which the coating applied to the anode collector and the coating applied to the cathode collector further comprise a binder, a conductive agent and a stabiliser.

Example Ex14: An aerosol-generating device according to Ex13, in which the binder comprises one or more of polyvinylidenefluoride, polyhexafluoropropylene-polyvinylidenefluoride copolymer, poly(vinylacetate), polyvinylalcohol, polyethyleneoxide, polyvinylpyrrolidone, alkylated polyethyleneoxide, polyvinylether, poly(methylmethacrylate), poly(ethylacrylate), polytetrafluorethylene, polyvinylchloride, polyacrylonitrile, polyvinylpyridine, styrene-butadiene rubber, and acrylonitrile-butadiene rubber.

Example Ex15: An aerosol-generating device according to Ex14, in which the binder is present in the respective coating in a concentration of 0.1% to 30% by weight of the coating, or 1% to 10% by weight of the coating.

Example Ex16: An aerosol-generating device according to any one of Ex13 to Ex15, in which the conductive agent comprises one or more of a graphitic agent, a carbon-black agent, a metal, and a metallic compound agent.

Example Ex17: An aerosol-generating device according to Ex16, in which the graphitic agent comprises one or more of artificial graphite and natural graphite.

Example Ex18: An aerosol-generating device according to either one of Ex16 or Ex17, in which the carbon-black agent comprises one or more of acetylene black, ketjen black, denka black, thermal black, and channel black.

Example Ex19: An aerosol-generating device according to any one of Ex16 to Ex18, in which the metal or metallic compound agent comprises one or more of Sn, SnO₂, SnPO₄, TiO₂, KTiO₃, LaSrCoO₃, and LaSrMnO₃.

Example Ex20: An aerosol-generating device according to any one of Ex16 to Ex19, in which the conductive agent is present in the coating in a concentration of 0.1% to 10% by weight of the coating.

Example Ex21: An aerosol-generating device according to any one of Ex1 to Ex20, in which the battery further comprises a permeable barrier configured to allow passage of lithium ions there-through, the permeable barrier positioned in the electrolyte between the anode and cathode.

Example Ex22: An aerosol-generating device according to Ex1, in which the halogenated carbonate comprises fluoroethylene carbonate, preferably wherein the cathode-active material comprises lithium iron phosphate.

Example Ex23: An aerosol-generating device according to Ex22, in which the electrolyte comprises LiPF₆.

Example Ex24: An aerosol-generating device according to either one of Ex22 or Ex23, in which the cathode-active material comprises one or more of lithium iron phosphate, lithium-nickel-manganese-cobalt oxide and lithium-cobalt oxide.

Example Ex25: An aerosol-generating device according to any one of Ex22 to Ex24, in which the anode-active material comprises graphite.

Example Ex26: An aerosol-generating device according to any one of Ex1 to Ex25, in which the lithium-ion battery is a rechargeable battery.

Example Ex27: An aerosol-generating device according to any one of Ex1 to Ex26, further comprising:
an electrically-powered heating arrangement; and
control electronics configured to control a supply of energy from the battery to the heating arrangement.

Example Ex28: An aerosol-generating device according to Ex27, in which the electrically-powered heating arrangement comprises a resistive heating element.

Example Ex29: An aerosol-generating device according to Ex27, in which the electrically-powered heating arrangement comprises an inductor configured to induce eddy currents into a susceptor.

Example Ex30: An aerosol-generating device according to Ex29, in which the electrically-powered heating arrangement further comprises a susceptor.

Example Ex31: An aerosol-generating device according to any one of Ex1 to Ex30, further comprising:
a membrane for evolving an aerosol from an aerosol-forming substrate through vibration of the membrane;
an actuator coupled to the membrane; and
control electronics configured to control a supply of energy from the battery to the actuator to drive vibration of the membrane.

Example Ex32: An aerosol-generating device according to any one of Ex1 to Ex31, in which the aerosol-generating device is configured to receive an aerosol-generating article comprising an aerosol-forming substrate.

Example Ex33: An aerosol-delivery system comprising an aerosol-generating device according to any one of Ex1 to Ex32 and an aerosol-generating article comprising an aerosol-forming substrate, in which the aerosol-generating device is configured to receive the aerosol-generating article.

Examples will now be further described with reference to the figures, in which:

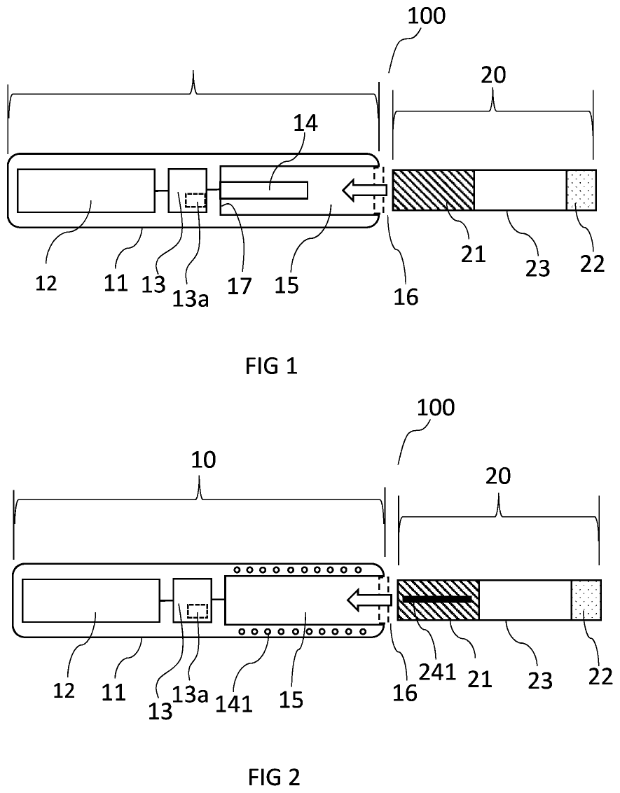

FIG. 1 illustrates a schematic view of a first embodiment of an aerosol-generating device and aerosol-delivery system according to the present disclosure;

FIG. 2 illustrates a schematic view of a second embodiment of an aerosol-generating device and aerosol-delivery system according to the present disclosure;

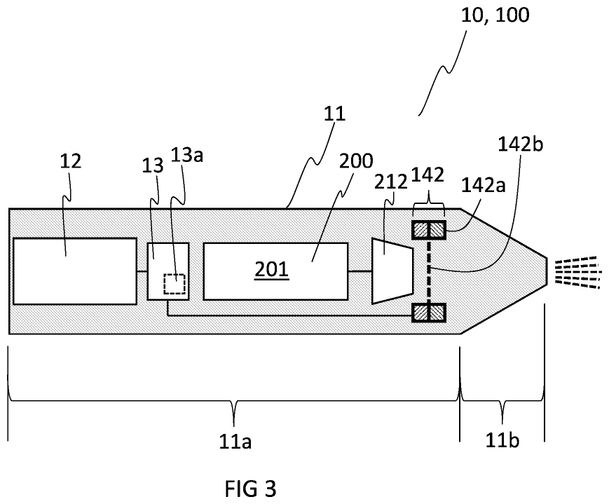

FIG. 3 illustrates a schematic view of a third embodiment of an aerosol-generating device and aerosol-delivery system according to the present disclosure;

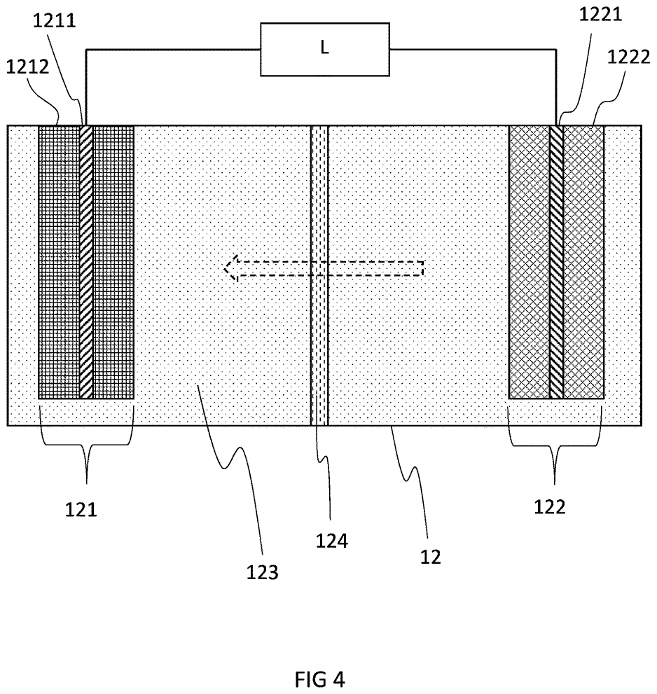

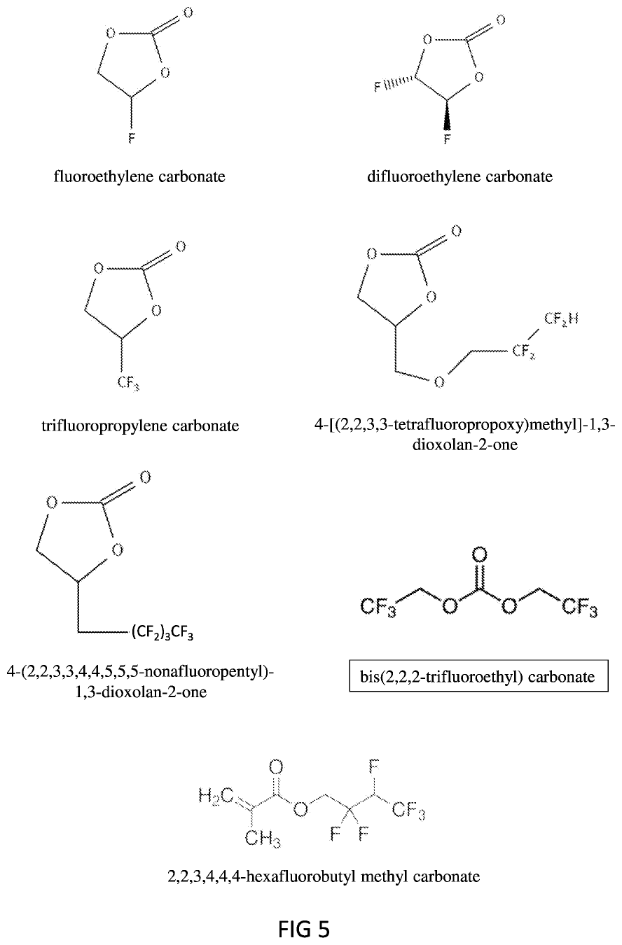

FIG. 4 illustrates a schematic view of a lithium-ion battery according to the present disclosure, which is suitable for use in the aerosol-generating device of FIGS. 1 to 3;

FIG. 5 is a schematic representation of the chemical structure of seven different halogenated carbonates for use as an additive to the electrolyte of a battery, such as the battery shown in FIG. 4.

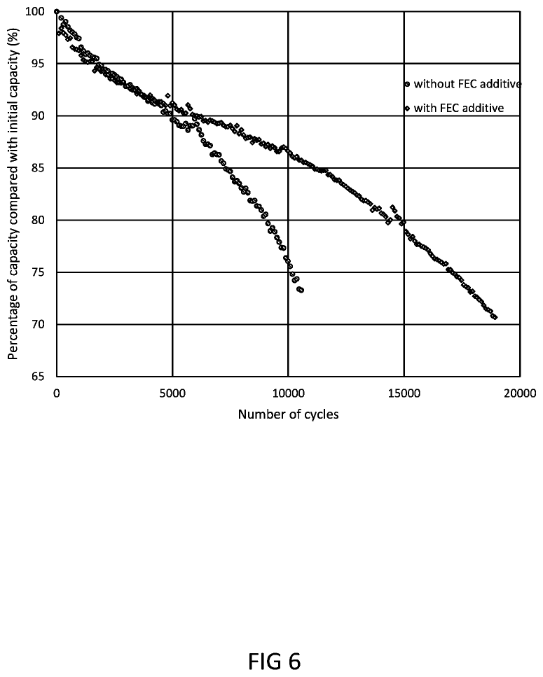

FIG. 6 provides a graph showing the variation in maximum capacity versus the number of charge cycles for a lithium-ion battery containing fluoroethylene carbonate (FEC) and a corresponding battery lacking FEC.

FIG. 1 shows an exemplary aerosol-generating device 10. The aerosol-generating device 10 is a hand-held aerosol generating device, and has an elongate shape defined by a housing 11 that is substantially circularly cylindrical in form. The housing 11 contains a lithium-ion battery 12, control electronics 13 and an electrically powered heating element 14. A blind cavity 15 is located at a proximal end 16 of the housing 11 for receiving an aerosol-generating article 20. The heating element 14 extends from a closed end 17 of the cavity 15 longitudinally along the cavity. The heating element 14 is a resistive heater element. The combination of aerosol-generating device 10 and aerosol-generating article 20 forms an aerosol-delivery system 100.

The aerosol-generating article 20 has the form of a cylindrical rod, the rod formed by a combination of an aerosol-forming substrate 21 and a filter element 22. The aerosol-forming substrate 21 and filter element 22 are co-axially aligned and enclosed in a wrapper 23 of cigarette paper. The aerosol-forming substrate 21 is a solid aerosol-forming substrate comprising tobacco. However, in alternative embodiments, the aerosol-forming substrate 21 may instead be a liquid aerosol-forming substrate or formed of a combination of liquid and solid aerosol-forming substrates. The filter element 22 serves as a mouthpiece of the aerosol-generating article 20. The aerosol-generating article 20 has a diameter substantially equal to the diameter of the cavity 15 of the device 10 and a length longer than a depth of the cavity. When the aerosol-generating article 20 is received in the cavity 15 of the device 10, the portion of the article containing the filter element 22 extends outside of the cavity and may be drawn on by a user, in a similar manner to a conventional cigarette.

The lithium-ion battery 12 serves as a source of electrical power to support operation of the aerosol-generating device 10. The control electronics 13 is configured to control a supply of energy from the battery 12 to the resistive heating element 14 during use of the device 10 over a usage session. The control electronics 13 includes or is coupled to a memory module 13a. In use, the control electronics 13 controls the supply of energy from the lithium-ion battery 12 to the resistive heating element 14 in accordance with instructions and data stored in the memory module 13a. The memory module 13a contains instructions and data governing when and the duration for which electrical power is supplied from the battery 12 to the heating element 14. The instructions and data may include a target thermal profile for the heating element 14 over a usage session. The target thermal profile defines a target operating temperature for the heating element 14. The target operating temperature may be defined as a function of time elapsed in a given usage session, or as a function of the number of puffs applied to the device 10 in a given usage session, or a combination thereof. The duration of the usage session may be defined by the first to occur of the usage session having continued for a predetermined maximum time duration and the number of puffs applied to the aerosol-generating article 20 having reached a predetermined maximum number of applied puffs. By way of example, the predetermined maximum time duration is 6 minutes and the predetermined maximum number of applied puffs is 14.

FIG. 2 shows an alternative embodiment to the aerosol-generating device 10 of FIG. 1. Instead of the resistive heating element 14 of the device 10 of FIG. 1, the aerosol-generating device 10 of FIG. 2 has an induction coil 141 provided within the housing 11 and surrounding a tubular wall, the tubular wall defining the cavity 15. For the illustrated embodiment, a susceptor 241 is embedded within the aerosol-forming substrate 21 of the aerosol-generating article 20. However, in an alternative embodiment, the susceptor may instead form part of the aerosol-generating device 10; for the example, the susceptor may define the tubular wall of the cavity 15. In use, the control electronics 13 controls the supply of energy from the lithium-ion battery 12 to the induction coil 141 in accordance with instructions and data stored in the memory module 13a, in a similar manner to the methodology described with reference to the embodiment of FIG. 1. With the aerosol-generating article 20 fully inserted into the cavity 15, the susceptor 241 is located within the induction coil 141. Current flow through the induction coil 141 induces eddy currents through and consequent heating of the susceptor 241.

FIG. 3 shows an alternative embodiment to the heat-related aerosol-generating devices of FIGS. 1 and 2. The aerosol-generating device 10 of FIG. 3 generates aerosol from an aerosol-forming substrate through vibration of a membrane in contact with the substrate, rather than through heating of the substrate. In common with the aerosol-generating devices 10 of FIGS. 1 and 2, the aerosol-generating device 10 of FIG. 3 has a housing 11 containing a lithium-ion battery 12 and control electronics 13. The housing 11 has a first housing part 11a and a second housing part 11b. The first housing part 11a is in the form of a cylindrical tube and is connected to the second housing part 11b. The second housing part 11b defines a mouthpiece of the aerosol-generating device 10, with an opening provided at one end of the mouthpiece. A replaceable/disposable cartridge 200 is located within the housing 11. The cartridge 200 contains a reservoir of liquid aerosol-forming substrate 201. A feed assembly 212 is fluidically coupled to and located downstream of the cartridge 200. The feed assembly 212 may be a passive structure, such as a wicking element. Alternatively, the feed assembly 212 may be an active feed assembly (such as a pump or similar) powered by the battery 12. A vibratory aerosolisation module 142 is provided downstream of the feed assembly 212. The aerosolisation module 142 includes an actuator assembly 142a coupled to a perforated membrane 142b. The actuator assembly 142a is coupled to the battery 12 via the control electronics 13. In use, the control electronics 13 controls the supply of energy from the lithium-ion battery 12 to the actuator assembly 142a in accordance with instructions and data stored in the memory module 13a. The control electronics 13 provides a driving signal to the actuator assembly 142a, with the actuator assembly inducing a vibratory response from the membrane 142b. The feed assembly 212 feeds liquid aerosol-forming substrate 201 from the cartridge 200 to one side of the membrane 142b. Vibration of the membrane 142b results in the substrate 201 being ejected through the perforated membrane and dispersed as a spray of aerosol droplets through the opening in the mouthpiece 11b-as shown schematically in FIG. 3.

For all three embodiments of aerosol-generating device 10 in FIGS. 1 to 3, the lithium-ion battery 12 serves as a source of electrical energy to facilitate generation of an inhalable aerosol from an aerosol-forming substrate 21, 201-whether through heating (as in FIGS. 1 and 2), or through vibration (as in FIG. 3). The aerosol-generating device 10 has a size and a mass which enable it to be hand-held by a user. The battery 12 provides high levels of energy over a short finite period of time-specifically, over a usage session. The battery 12 only has sufficient capacity to complete a predetermined number of usage sessions. On completion of the predetermined number of usage sessions, the battery 12 is recharged. The predetermined number of usage sessions may be a single usage session, or may be two or more usage sessions.

The following paragraphs describe an exemplary configuration for the battery 12 and describe how the use of a specific form of additive in an electrolyte of the battery may assist in enhancing the maximum capacity of the battery in a fully charged state over many thousands of charge cycles.

FIG. 4 illustrates a schematic view of the lithium-ion battery 12 as employed in the aerosol-generating devices 10 of FIGS. 1 to 3. FIG. 4 also includes a representation of the external circuit which is formed by connection of the battery to the control electronics 13 and other electrical loads of the aerosol-generating device 10. The other electrical loads would include the resistive heater element 14 of FIG. 1, the induction coil 141 of FIG. 2 and the actuator assembly 142a of the vibratory aerosolisation module 142 of FIG. 3. The control electronics 13 and these other electrical loads are represented by reference sign “L” in FIG. 4.

FIG. 4 shows a single cell of the lithium-ion battery 12. The cell of the lithium-ion battery 12 has a pair of electrodes in the form of an anode 121 and a cathode 122. The anode and cathode are spaced apart from each other in an electrolyte 123. A separator 124 is positioned in the cell between the anode 121 and cathode 122. It will be appreciated that in other embodiments, the battery 12 may comprise multiple cells.

The anode 121 has an anode collector 1211 formed of copper foil. The anode collector 1211 is coated with an anode-active material 1212. The anode-active material 1212 is formed of graphite. The cathode 122 has a cathode collector 1221 formed of aluminium foil. The cathode collector 1221 is coated with a cathode-active material 1222. The cathode-active material 1222 is formed of lithium-iron phosphate.

In other embodiments, the anode-active material is formed of materials other than graphite, such as silicon, lithium titanate oxide, or an allotrope of carbon other than graphite. Further, in other embodiments the cathode-active material is formed of materials other than lithium-iron phosphate, such as being one or more of lithium nickel-cobalt-aluminium oxide, lithium-cobalt oxide, lithium-manganese oxide, lithium-nickel-manganese oxide, lithium-manganese-cobalt oxide, lithium-nickel-manganese-cobalt oxide, and lithium sulphur.

The electrolyte 123 is formed of a non-aqueous organic solvent, a lithium salt and a halogenated carbonate additive. For the embodiment described, the halogenated carbonate is fluoroethylene carbonate (FEC) and the lithium salt is LiPF₆, with FEC being present in the electrolyte in a concentration of between 0.1% to 2% by weight of the electrolyte. The FEC is dissolved in the non-aqueous organic solvent of the electrolyte. In other embodiments the halogenated carbonate is other than FEC, such as being one or more of difluoroethylene carbonate (DFEC), trifluoropropylene carbonate (TFPC), 4-[(2,2,3,3-tetrafluoropropoxy)methyl]-1,3-dioxolan-2-one (HFEEC), 4-(2,2,3,3,4,4,5,5,5-nonafluoropentyl)-1,3-dioxolan-2-one (NFPEC), bis(2,2,2-trifluoroethyl) carbonate (TFEC) and 2,2,3,4,4,4-hexafluorobutyl methyl carbonate (HFBMC). FIG. 5 provides a schematic representation of FEC and six alternative forms of halogenated carbonate which may be used instead of FEC. Similarly, in other embodiments the lithium salt is other than LiPF₆, such as being one or more of LiBF₄, LiSbF₆, LiAsF₆, LiClO₄, LiCF₃SO₃, LiN(SO₂CF₃)₂, LiN(SO₂C₂F₅)₂, LiC(SO₂CF₃)₃, LiN(SO₃CF₃)₂, LiC₄F₉SO₃, LiAlO₄, LiAlCl₄, LiCl, and Lil. In other embodiments, the concentration of FEC or other halogenated carbonate in the electrolyte is 0.05% to 15% by weight of the electrolyte, or between 0.05% to 10% by weight of the electrolyte, or between 0.05% to 5% by weight of the electrolyte.

When the battery is being discharged (for example, when providing electricity to the control electronics 13 and other electrical loads of the aerosol-generating device 10 previously described), lithium ions flow from the cathode 122 to the anode 121 through the electrolyte 123 and separator 124 (as indicated by the broken arrow in FIG. 4). Further, electrons flow from the anode 121 towards the cathode 122 via the external circuit and its components L. The direction of passage of the ions reverses when the battery 12 is being charged, i.e. from the anode 121 towards the cathode 122.

FIG. 6 illustrates the percentage maximum capacity of a battery (relative to its initial capacity) versus the number of charge cycles for two different batteries, the batteries differing only in whether or not they contain FEC as an additive in the electrolyte. The two batteries are made as follows:

Firstly, a mixture is provided of lithium iron phosphate as a cathode-active material, polyvinylidenefluoride (PVDF) as a binder and carbon as a conductive agent in relative weight ratios of between 94:3:3 and 96:2:2. These constituent elements are mixed together in a non-aqueous solvent of N-methyl-2-pyrrolidine (NMP)) to form a cathode-active slurry. The slurry is then coated onto an aluminium foil collector of between 10 to 40 micrometres thickness, and then dried and rolled to produce the cathode.

Secondly, a mixture is provided of synthetic graphite as an anode-active material, styrene-butadiene rubber (SBR) as a binder and carboxylmethyl cellulose as a stabiliser in relative weight ratios of 92:4:4 to 94:3:3. These constituent elements are mixed together in water to produce an anode-active slurry. The slurry is then coated onto a copper foil collector of between 10 to 30 micrometres thickness, and then dried and rolled to produce the anode.

Each battery uses an anode and cathode made according to the above paragraphs. The anode and cathode are placed in an electrolyte, in which the electrolyte is made by dissolving LiPF₆ in a non-aqueous organic solvent. A separator formed of polyethylene of 7 to 12 micrometres thickness is located between the anode and cathode. For the first battery, 0.1 to 0.2% by weight of fluoroethylene carbonate (FEC) is added to the electrolyte solution; the weight percentage of FEC is relative to the weight of the non-aqueous organic solvent alone. For the second battery, no FEC is added to the electrolyte solution.

Both batteries were then charged for 0.1 hours at a temperature of 25 degrees Celsius under conditions of 6 C/3.65 Volts of constant current and constant voltage and then discharged under conditions of 10 to 20 C of pulse current and 2.55 V as a lower limit voltage. ‘C’ is a multiplier for the charge or discharge rate of the battery; a rate of 1C equates to a battery being charged from 0 to 100% in one hour, and a rate of 2C achieves the same level of charging in half the time, i.e. 30 minutes. The charge/discharge cycle outlined above was repeated over around 10,000 cycles and the maximum capacity of the battery as a percentage of the battery's initial capacity calculated. FIG. 6 provides a pictorial illustration of how incorporating FEC in the electrolyte results in a significant increase in the battery's maximum capacity after the number of charge/discharge cycles exceeds around 6,000 in number. More specifically, when considering the percentage maximum capacity remaining at the 10,560^{th} cycle, it was seen that the maximum capacity for the battery lacking FEC drops below 75% whereas the maximum capacity of the battery including FEC remains above 85% of the battery's initial capacity.

For the same two batteries discussed above (one with and one without FEC added to the electrolyte), tests were also performed to determine whether each battery was able to provide 170 mAh when discharged from a fully charged state at a temperature of 5 degrees Celsius. It was found that the battery containing FEC was able to achieve a 100% passing rate, whereas the battery lacking FEC was only able to achieve a 40% passing rate.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number “A” is understood as “A” ±10% of “A”. Within this context, a number “A” may be considered to include numerical values that are within general standard error for the measurement of the property that the number “A” modifies. The number “A”, in some instances as used in the appended claims, may deviate by the percentages enumerated above provided that the amount by which “A” deviates does not materially affect the basic and novel characteristic(s) of the claimed invention. Also, all ranges include the maximum and minimum points disclosed and include any intermediate ranges therein, which may or may not be specifically enumerated herein.

1.-15. (canceled)

16. An aerosol-generating device for generating an inhalable aerosol from an aerosol-forming substrate, the aerosol-generating device comprising:
a lithium-ion battery comprising an electrolyte and at least one pair of electrodes,
the at least one pair of electrodes being spaced apart from each other in the electrolyte, one of the pair of electrodes defining an anode and comprising an anode-active material, the other of the pair of electrodes defining a cathode and comprising a cathode-active material, and
the electrolyte including a halogenated carbonate,
wherein the halogenated carbonate comprises one or more of difluoroethylene carbonate, trifluoropropylene carbonate, 4-[(2,2,3,3-tetrafluoropropoxy)methyl]-1,3-dioxolan-2-one, 4-(2,2,3,3,4,4,5,5,5-nonafluoropentyl)-1,3-dioxolan-2-one, bis(2,2,2-trifluoroethyl) carbonate, and 2,2,3,4,4,4-hexafluorobutyl methyl carbonate.

17. The aerosol-generating device according to claim 16, wherein the halogenated carbonate is present in the electrolyte in a concentration of 0.05% to 15% by weight of the electrolyte, or between 0.05% to 10% by weight of the electrolyte, or between 0.05% to 5% by weight of the electrolyte, or between 0.1% to 2% by weight of the electrolyte.

18. The aerosol-generating device according to claim 16, wherein the electrolyte comprises a lithium salt.

19. The aerosol-generating device according to claim 18, wherein the lithium salt comprises one or more of LiPF₆, LiBF₄, LiSbF₆, LiAsF₆, LiClO₄, LiCF₃SO₃, LiN(SO₂CF₃)₂, LiN(SO₂C₂F₅)₂, LiC(SO₂CF₃)₃, LiN(SO₃CF₃)₂, LiC₄F₉SO₃, LiAlO₄, LiAlCl₄, LiCl, and Lil.

20. The aerosol-generating device according to claim 16, wherein the anode-active material comprises one or more of carbon, an allotrope of carbon, lithium titanate oxide, and silicon.

21. The aerosol-generating device according to claim 20, wherein the allotrope of carbon comprises graphite.

22. The aerosol-generating device according to claim 16,
wherein the anode comprises an anode collector, and
wherein a coating comprising the anode-active material is applied to the anode collector.

23. The aerosol-generating device according to claim 21, wherein the anode collector comprises copper.

24. The aerosol-generating device according to claim 16, wherein the cathode-active material comprises one or more of lithium iron phosphate, lithium nickel-cobalt-aluminium oxide, lithium-cobalt oxide, lithium-manganese oxide, lithium-nickel-manganese oxide, lithium-manganese-cobalt oxide, lithium-nickel-manganese-cobalt oxide, and lithium sulphur.

25. The aerosol-generating device according to claim 16, wherein the halogenated carbonate comprises fluoroethylene carbonate.

26. The aerosol-generating device according to claim 16, wherein the cathode-active material comprises lithium iron phosphate.

27. The aerosol-generating device according to claim 24, wherein the cathode-active material comprises one or more of lithium iron phosphate, lithium-nickel-manganese-cobalt oxide, and lithium-cobalt oxide.

28. The aerosol-generating device according to claim 16, wherein the lithium-ion battery is a rechargeable battery.

29. The aerosol-generating device according to claim 16, wherein the aerosol-generating device is configured to receive an aerosol-generating article comprising an aerosol-forming substrate.

30. The aerosol-generating device according to claim 16, further comprising:
an electrically-powered heating arrangement; and
control electronics configured to control a supply of energy from the lithium-ion battery to the electrically-powered heating arrangement.

31. An aerosol-delivery system comprising an aerosol-generating device according to claim 16 and an aerosol-generating article comprising an aerosol-forming substrate, wherein the aerosol-generating device is configured to receive the aerosol-generating article.
